(19) United States
(12) Patent Application Publication
(10) Pub. No.: US 2020/0193385 A1
(43) Pub. Date: Jun. 18, 2020

(54) METHODS, APPARATUSES AND COMPUTER PROGRAM PRODUCTS FOR COST/RATE COMPARISON RELATING TO HIRING WORKFLOWS

(71) Applicant: APC Workforce Solutions, LLC, Orlando, FL (US)

(72) Inventors: Nancy Daniel Hecker, Orlando, FL (US); Mark Woytowicz Wyatt, Santa Rosa, CA (US)

(21) Appl. No.: 16/712,560

(22) Filed: Dec. 12, 2019

Related U.S. Application Data
(60) Provisional application No. 62/778,388, filed on Dec. 12, 2018.

(51) Int. Cl. G06Q 10/10

(52) U.S. Cl. CPC G06Q 10/1053

(57) ABSTRACT

An apparatus comprising a processor and a memory, the memory storing computer-executable instructions which when executed by the processor, cause the apparatus to perform operations comprising: determine submitted rates for one or more workforce resources associated with a requisition, wherein each of the one or more workforce resources is associated with a job type and a location; determine, based on at least the job type and the location, a market pay rate for each of the one or more workforce resources; output, based on the submitted rates and a number of working units, a first total cost for each of the one or more workforce resources; output, based on the market pay rate and the number of working units, a second total cost for each of the one or more workforce resources; and output a function of the first total cost and the second total cost.

### CROSS-REFERENCE TO RELATED APPLICATIONS

This application claims the benefit of U.S. Provisional Patent Application No. 62/778,388, filed on Dec. 12, 2018, entitled “Methods, Apparatuses And Computer Program Products For Cost/Rate Comparison Relating to Hiring Workflows,” the contents of which are hereby incorporated by reference herein in its entirety.

### TECHNICAL FIELD

The present disclosure relates generally to methods, apparatuses and computer program products for improving techniques of cost and rate comparisons relating to hiring workflows.

### BACKGROUND

One manner in which to supplement an existing workforce is for organizations (e.g., corporations, institutions (e.g., universities), other businesses) to hire one or more independent contractors to assist with professional service needs. Professional services may involve using specialists to support the business by providing tax advice, accounting assistance, information technology (IT) services assistance, providing management advice, etc. Another way to supplement an existing workforce is for organizations to hire one or more workforce resources (e.g., independent contractors) to assist with a variety of tasks for a certain period of time based on the needs of the organization. A job requisition may be used to request supplemental work assistance.

### SUMMARY

A method, apparatus and computer program product are therefore provided for providing improved techniques of cost and rate comparisons relating to hiring workflows, as described more fully below.

In one example embodiment, an apparatus may include a processor and memory including computer-executable instructions. The memory and the computer-executable instructions are configured to, with the processor, cause the apparatus to at least perform operations including determining submitted rates for one or more workforce resources associated with a requisition, wherein each of the one or more workforce resources is associated with a job type and a location. The memory and computer-executable instructions are also configured to, with the processor, cause the apparatus to determine, based on at least the job type and the location, a market pay rate for each of the one or more workforce resources. The memory and computer-executable instructions are also configured to, with the processor, cause the apparatus to output, based on the submitted rates and a number of working units, a first total cost for each of the one or more workforce resources. The memory and computer-executable instructions are also configured to, with the processor, cause the apparatus to output, based on the market pay rate and the number of working units, a second total cost for each of the one or more workforce resources. The memory and computer-executable instructions are also configured to, with the processor, cause the apparatus to output a function of the first total cost and the second total cost.

In another example embodiment, a computer implemented method may include determining submitted rates for one or more workforce resources associated with a requisition, wherein each of the one or more workforce resources is associated with a job type and a location. The method may further include determining, based on at least the job type and the location, a market pay rate for each of the one or more workforce resources. The method may further include outputting, based on the submitted rates and a number of working units, a first total cost for each of the one or more workforce resources. The method may further include outputting, based on the market pay rate and the number of working units, a second total cost for each of the one or more workforce resources. The method may further include outputting a function of the first total cost and the second total cost.

In another example embodiment, a computer program product may include at least one computer-readable storage medium having computer-executable program code instructions stored therein. The computing-executable program code instructions may include program code instructions configured to determine submitted rates for one or more workforce resources associated with a requisition, wherein each of the one or more workforce resources is associated with a job type and a location. The computer readable storage medium storing the executable instructions when further executed by the computing device may cause the computing device to determine, based on at least the job type and the location, a market pay rate for each of the one or more workforce resources. The computer readable storage medium storing the executable instructions when further executed by the computing device may cause the computing device to output, based on the submitted rates and a number of working units, a first total cost for each of the one or more workforce resources. The computer readable storage medium storing the executable instructions when further executed by the computing device may cause the computing device to output, based on the market pay rate and the number of working units, a second total cost for each of the one or more workforce resources. The computer readable storage medium storing the executable instructions when further executed by the computing device may cause the computing device to output a function of the first total cost and the second total cost.

Additional advantages will be set forth in part in the description which follows or may be learned by practice. It is to be understood that both the foregoing general description and the following detailed description are exemplary and explanatory only and are not restrictive.

### BRIEF DESCRIPTION OF THE DRAWINGS

The accompanying drawings, which are incorporated in and constitute a part of this specification, illustrate embodiments and together with the description, serve to explain the principles of the methods and systems.

FIG. 1 is a schematic block diagram of a system according to an exemplary embodiment of the present disclosure;

FIG. 2 is a block diagram illustrating an example computing device according to an exemplary embodiment of the present disclosure;

FIG. 3 is an example report in accordance with an aspect of the present disclosure;

FIG. 4 is a block diagram of a system according to an exemplary embodiment of the present disclosure;

FIG. 5A is a diagram illustrating an exemplary user interface according to an exemplary embodiment of the present disclosure;

FIG. 5B is a diagram illustrating an exemplary user interface according to an exemplary embodiment of the present disclosure;

FIG. 6 is a flow diagram of an exemplary method according to an exemplary embodiment of the present disclosure; and

FIG. 7 is a flow diagram of an exemplary method according to an exemplary embodiment of the present disclosure.

### DETAILED DESCRIPTION

Some embodiments of the present disclosure will now be described more fully hereinafter with reference to the accompanying drawings, in which some, but not all embodiments of the present disclosure are shown. Indeed, various embodiments of the present disclosure may be embodied in many different forms and should not be construed as limited to the embodiments set forth herein. Like reference numerals refer to like elements throughout. As used herein, the terms “data,” “content,” “information” and similar terms may be used interchangeably to refer to data capable of being transmitted, received and/or stored in accordance with embodiments of the present disclosure. Moreover, the term “exemplary”, as used herein, is not provided to convey any qualitative assessment, but instead merely to convey an illustration of an example. Thus, use of any such terms should not be taken to limit the spirit and scope of embodiments of the present disclosure.

As defined herein a “computer-readable storage medium,” which refers to a non-transitory, physical or tangible storage medium (e.g., volatile or non-volatile memory device), may be differentiated from a “computer-readable transmission medium,” which refers to an electromagnetic signal.

As referred to herein, a customer(s)/client(s) may refer to a hiring party that may need to supplement an existing workforce. Additionally, as referred to herein, a “party” may refer to a person, a group of persons, a business entity, institution or the like.

As referred to herein, a manager(s) may refer to a user (e.g., an individual) that oversees and manages one or more requisitions that may, but need not, be associated with responses to Requests for Proposal (RFP), Requests for Information (RFI) or the like pertaining to products and/or services that may be requested by a customer(s)/client(s).

As referred to herein, a service provider(s) may refer to an entity (e.g., a company, organization, institution, individual, etc.) that submits, to a manager(s), a response to a requisition(s) requesting a workforce resource that may, but need not, be associated with an RFP or RFI.

As referred to herein, an administration (Admin) user may refer to a managed service provider (MSP), which may be an outsourced agency that manages the non-employee workforce (e.g., independent contractors, temporary workers, companies that provide services via a SOW) for a client.

As referred to herein, a vendor management system (VMS) may refer to an application that acts as a mechanism for an organization to manage and procure staffing services, which may be temporary or permanent placement services, as well as outside contract or contingent labor. The VMS may distribute job requisitions/requirements to staffing companies, recruiters, consulting companies, and other vendors (i.e., independent consultants). The VMS may facilitate interviews and other aspects of a hiring process, as well as labor time collection approval and payment upon services rendered by a workforce resource.

As referred to herein, a workforce resource(s) may refer to an independent contractor(s), consultant(s), freelancer(s), or other outsourced non-permanent worker(s) hired on a per-project basis.

As referred to herein, a workflow may refer to creating and managing one or more requisitions with various access rights (e.g., view, add/update, and/or edit features, etc.) based on selected options generated by an organization via a user interface(s). In some example embodiments, each requisition may be associated with a requisition type at the outset of a requisition creation workflow.

As referred to herein, a job requisition (e.g., a form, a document, data presented via a user interface) may be used to request hiring of one or more workforce resources (e.g., permanent and/or temporary workers), describing the manner in which the hiring of one or more individuals is needed and may describe the budget available for a role/position.

A statement of work (SOW) may be used by an organization to define the work to be performed and the needs of the organization to be fulfilled by the independent contractors. The SOW may also indicate a particular contractor/vendor and define project-specific activities, deliverables and timelines for a vendor/service provider providing services to the organization. The SOW may also include detailed requirements and pricing, as well as invoicing with standard regulatory and governance terms and conditions.

As referred to herein, staff augmentation may be a strategy used to staff a project and respond to business objectives with the use of contingent labor. Augmentation may refer to evaluating existing staff to identify where skills gaps exist and then filling the gaps. The gaps may be filled with the assistance of a staffing firm that is employed to find and provide contract professionals.

As referred to herein, a market rate may refer to a rate for a job category and/or location as a whole, without particular respect to the customer.

As referred to herein, a job taxonomy may refer to naming, describing and classifying jobs based on, for example, a job category, skill, education level, certification, license, etc. The job taxonomy may be composed of one or more staff augmentation classifications and/or one or more SOW classifications. A global job taxonomy may be composed of a list of classifications that is not editable.

As referred to herein, the Occupational Information Network (O*NET) may be a database that includes occupational definitions based on occupational requirements and worker attributes, which are assigned a code (O*NET code). O*NET describes occupations in terms of the skills and knowledge required, how the work is performed, and typical work settings.

As referred to herein, a rate card may refer to information (e.g., information in a form, document, user interface, etc.) outlining how much a service provider may charge for the time of each of workforce resource requested by a hiring party to complete a project (e.g., daily or hourly rate).

It is to be understood that the methods and systems described herein are not limited to specific methods, specific components, or to particular implementations. It is also to be understood that the terminology used herein is for the purpose of describing particular exemplary embodiments only and is not intended to be limiting.

A customer (also referred to as a “hiring party”) may need to supplement an existing workforce. In order to supplement the existing workforce, the customer may submit a SOW requisition for one or more workforce resources to a service provider (also referred to as a “supplier”). However, the customer may be unfamiliar with market rates for workers for a given job category and/or locale (e.g., city, metropolitan area, state, etc.). A lack of clarity for market rates, as well as onshore worker costs and offshore worker cost when obtaining workforce resources may lead to cost overages and budgeting difficulty for the customer due to paying above market rate for workforce resources needed to perform work associated with the SOW requisition. Moreover, when conducting negotiations to obtain a workforce resource(s) associated with the SOW requisition, using a computing device in which the customer and service provider conduct negotiations over a network via an associated device, the lack of clarity may result in multiple rounds of negotiations facilitated by a computing device between the customer and service provider, which may inefficiently consume processing capacity and memory capacity of the computing device. Applicant has identified that conserving processing resources and memory space are important to improving any implementation of a more efficient manner for performing workforce resource analysis. Because the exemplary embodiments enable a vendor management server to provide a customer with sample market rates and a total cost difference based on submissions by the service provider, a number of negotiations (e.g., electronic negotiations) performed by the vendor management server to obtain workforce resources to fulfill the SOW requisition may be reduced, enabling the vendor management server to reduce consumption of processing resources, conserve memory space and minimize network traffic (e.g., conserve network bandwidth). As such, systems structured in accordance with various embodiments of the invention provide specific, technical solutions to technical problems faced by some systems.

Systems, methods, and apparatuses are described for workforce resource analysis and workforce management. A method may comprise determining a sample market rate for each workforce resource to fulfill the SOW requisition based on a job type and/or a location associated with the SOW requisition. The sample market rate may comprise a monetary rate or amount that a service provider or intermediate party charges or retains for facilitating an engagement between a customer and a service provider for each workforce resource needed to fulfill a SOW requisition. Based on the sample market rate and rates submitted by a service provider, a total cost difference may be determined. The sample market rate may refer to a standard/average/median rate associated with a job category for a workforce resource, which may be based on a location or location type, that is not specific to a particular customer.

### General System Architecture

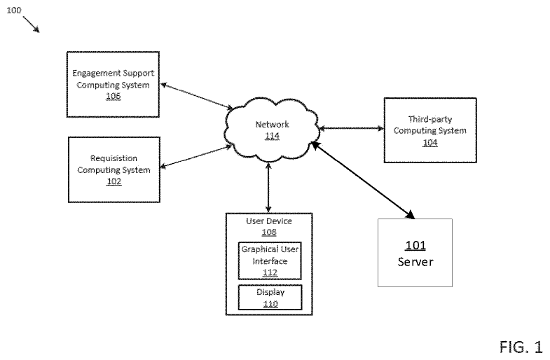

Referring to FIG. 1, a system 100 may include a requisition computing system 102, an engagement support computing system 106, and a third-party computing system 104. The system 100 may comprise a user device 108 configured with a display 110 to output a graphical user interface 112. The requisition computing system 102, the third-party computing system 104, the engagement support computing system 106, and the user device 108 may be in communication with a server 101 (e.g., a vendor management server) via network 114. The network 114 may include a wide area network (WAN), such as the Internet, a local area network (LAN), such as a wireless local area network (WLAN), or other type of networks.

The requisition computing system 102 may be associated with a user such as, for example, a customer. The engagement support computing system 106 may be associated with an entity such as, for example, a support party that assists or facilitates a customer in obtaining a workforce resource (e.g., one or more independent contractors). The customer may have a business agreement with the support party and may make payment to the support party for services. For example, the support party may perform workforce resource management or consulting for the customer. The support party may provide information relating to a SOW requisition and engagement to the customer, such as, for example, supplier markup data, market rate data, and/or historic rate data, to assist the customer in determining service providers to hire for fulfilling the SOW requisition.

The third-party computing system 104 may be associated with one or more other users such as, for example, other customers. In some example embodiments, the third-party computing system 104 may be associated with a party that collects and aggregates workforce resource data from various sources, such as, for example, various hiring parties. The requisition computing system 102 and the third-party computing system 104 may each store one or more project records associated with work performed by a service provider and/or one or more workforce resources. The project records stored by the requisition computing system 102 may include project records associated with the customer, such as project records indicating service provider and/or workforce resource hiring undertaken by a customer. The project records stored by the third-party computing system 104 may include project records associated with other hiring parties as well as project records associated with one or more customers. The third-party computing system 104 may serve as an external source of workforce resource data for a customer.

The requisition computing system 102, the engagement support computing system 106, and the third-party computing system 104 each may comprise one or more computing devices, such as a server computing device, personal computing device, mainframe computing device, network device, and distributed computing environment. The server 101, the requisition computing system 102, the engagement support computing system 106, and the third-party computing system 104 each may comprise a plurality of networked computing devices.

The user device 108 may include, for example, a personal computer, a laptop computer, or a mobile device. The user device 108 may include a display 110, and a graphical user interface 112. In some example embodiments, data may be provided to the graphical user interface 112 (e.g., for presentation/output) by a communication device (e.g., the server 101, the requisition computing system 102, the third-party computing system 104 and/or the engagement support computing system 106.

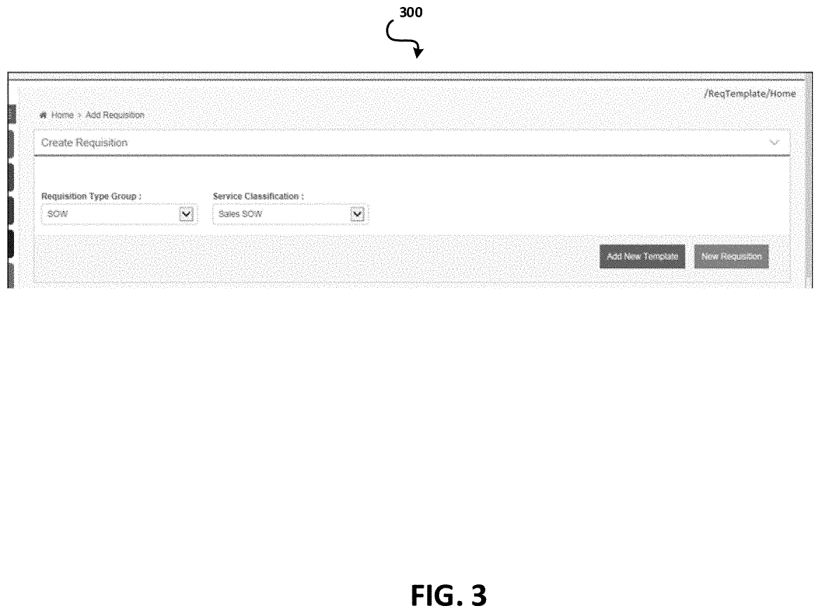

The graphical user interface 112 may include a user input interface. In some example embodiments, the user input interface may detect input and/or a selection of a request (e.g., by an entity such as a manager) for information relating to a SOW requisition, or other engagements. In some other example embodiments, the user input interface of the graphical user interface 112 may detect input (and/or a selection) of a workflow for generating and managing requisitions (e.g., SOW requisitions), which are further described in FIGS. 3-7.

The server 101 may receive and post one or more requisitions from, for example, requisition computing system 102. The server 101 may also receive one or more submissions from service providers, via engagement support computing system 106, in response to the one or more requisitions posted. The server 101 may also receive third party data (e.g., sample market rate data, from third parties, via the third-party computing system 104. The server 101 may use the received one or more submissions to generate a requisition page, which may be provided to the user device 101 and/or requisition computing system 102. The server 101 may use the received one or more submissions and the sample market rate data to generate a market comparison report, which may be provided to the user device 101 and/or requisition computing system 102.

### Computing Device

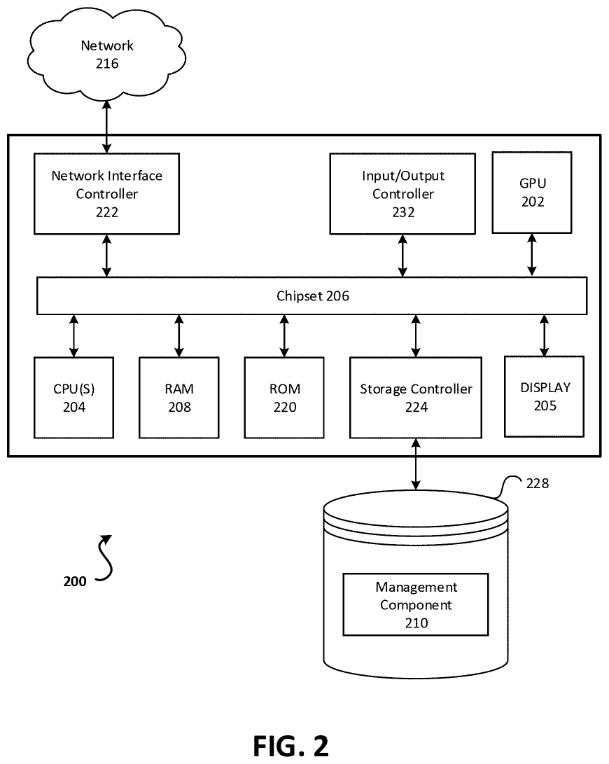

FIG. 2 depicts a computing device that may be used in various aspects, such as the servers, modules, and/or devices depicted in FIG. 1. With regard to the example architecture of FIG. 1, the server 101, requisition computing system 102, third party computing system 104, engagement support computing system 106, and user device 108 may each be implemented in an instance of a computing device 200 of FIG. 2. The computer architecture shown in FIG. 2 may illustrate a server computer, workstation, desktop computer, laptop, tablet, network appliance, PDA, e-reader, digital cellular phone, or other computing node, and may be utilized to execute any aspects of the computers described herein, such as to implement the methods described herein.

The computing device 200 may include a baseboard, or “motherboard,” which is a printed circuit board to which a multitude of components or devices may be connected by way of a system bus or other electrical communication paths. One or more central processing units (CPUs) 204 may operate in conjunction with a chipset 206. The CPU(s) 204 may be standard programmable processors that perform arithmetic and logical operations necessary for the operation of the computing device 200.

The CPU(s) 204 may perform the necessary operations by transitioning from one discrete physical state to the next through the manipulation of switching elements that differentiate between and change these states. Switching elements may generally include electronic circuits that maintain one of two binary states, such as flip-flops, and electronic circuits that provide an output state based on the logical combination of the states of one or more other switching elements, such as logic gates. These basic switching elements may be combined to create more complex logic circuits including registers, adders-subtractors, arithmetic logic units, floating-point units, and the like.

The CPU(s) 204 may be augmented with or replaced by other processing units, such as GPU(s) 202. The GPU(s) 202 may comprise processing units specialized for but not necessarily limited to highly parallel computations, such as graphics rendering and other visualization-related processing. In some examples, the GPU 202 may render a user interface(s), which may detect input (e.g., selections of a user) and present/output visible indicia.

A chipset 206 may provide an interface between the CPU(s) 204 and the remainder of the components and devices on the baseboard. The chipset 206 may provide an interface to a random-access memory (RAM) 208 used as the main memory in the computing device 200. The chipset 206 may further provide an interface to a computer-readable storage medium, such as a read-only memory (ROM) 220 or non-volatile RAM (NVRAM) (not shown), for storing basic routines that may help to start up the computing device 200 and to transfer information between the various components and devices. ROM 220 or NVRAM may also store other software components necessary for the operation of the computing device 200 in accordance with the aspects described herein.

The computing device 200 may operate in a networked environment using logical connections to remote computing nodes and computer systems through local area network (LAN) 216. The chipset 206 may include functionality for providing network connectivity through a network interface controller (NIC) 222, such as a gigabit Ethernet adapter. A NIC 222 may be capable of connecting the computing device 200 to other computing nodes over a network 216. It should be appreciated that multiple NICs 222 may be present in the computing device 200, connecting the computing device to other types of networks and remote computer systems.

The computing device 200 may be connected to a mass storage device 228 that provides non-volatile storage for the computer. The mass storage device 228 may store system programs, application programs, other program modules, and data, which have been described in greater detail herein. The mass storage device 228 may be connected to the computing device 200 through a storage controller 224 connected to the chipset 206. The mass storage device 228 may consist of one or more physical storage units. A storage controller 224 may interface with the physical storage units through a serial attached SCSI (SAS) interface, a serial advanced technology attachment (SATA) interface, a fiber channel (FC) interface, or other type of interface for physically connecting and transferring data between computers and physical storage units.

The computing device 200 may store data on a mass storage device 228 by transforming the physical state of the physical storage units to reflect the information being stored. The specific transformation of a physical state may depend on various factors and on different implementations of this description. Examples of such factors may include, but are not limited to, the technology used to implement the physical storage units and whether the mass storage device 228 is characterized as primary or secondary storage and the like.

For example, the computing device 200 may store information to the mass storage device 228 by issuing instructions through a storage controller 224 to alter the magnetic characteristics of a particular location within a magnetic disk drive unit, the reflective or refractive characteristics of a particular location in an optical storage unit, or the electrical characteristics of a particular capacitor, transistor, or other discrete component in a solid-state storage unit. Other transformations of physical media are possible without departing from the scope and spirit of the present description, with the foregoing examples provided only to facilitate this description. The computing device 200 may further read information from the mass storage device 228 by detecting the physical states or characteristics of one or more particular locations within the physical storage units.

In addition to the mass storage device 228 described above, the computing device 200 may have access to other computer-readable storage media to store and retrieve information, such as program modules, data structures, or other data. It should be appreciated by those skilled in the art that computer-readable storage media may be any available media that provides for the storage of non-transitory data and that may be accessed by the computing device 200.

By way of example and not limitation, computer-readable storage media may include volatile and non-volatile, transitory computer-readable storage media and non-transitory computer-readable storage media, and removable and non-removable media implemented in any method or technology. Computer-readable storage media includes, but is not limited to, RAM, ROM, erasable programmable ROM (“EPROM”), electrically erasable programmable ROM (“EEPROM”), flash memory or other solid-state memory technology, compact disc ROM (“CD-ROM”), digital versatile disk (“DVD”), high definition DVD (“HD-DVD”), BLU-RAY, or other optical storage, magnetic cassettes, magnetic tape, magnetic disk storage, other magnetic storage devices, or any other medium that may be used to store the desired information in a non-transitory fashion.

A mass storage device, such as the mass storage device 228 depicted in FIG. 2, may store an operating system utilized to control the operation of the computing device 200. The operating system may comprise a version of the LINUX operating system. The operating system may comprise a version of the WINDOWS SERVER operating system from the MICROSOFT Corporation. According to further aspects, the operating system may comprise a version of the UNIX operating system. Various mobile phone operating systems, such as IOS and ANDROID, may also be utilized. It should be appreciated that other operating systems may also be utilized. The mass storage device 228 may store other system or application programs and data utilized by the computing device 200.

The mass storage device 228 or other computer-readable storage media may also be encoded with computer-executable instructions, which, when loaded into the computing device 200, transforms the computing device from a general-purpose computing system into a special-purpose computer capable of implementing the aspects described herein. These computer-executable instructions transform the computing device 200 by specifying how the CPU(s) 204 transition between states, as described above. The computing device 200 may have access to computer-readable storage media storing computer-executable instructions, which, when executed by the computing device 200, may perform methods described herein.

A computing device, such as the computing device 200 depicted in FIG. 2, may also include an input/output controller 232 for receiving and processing input from a number of input devices, such as a keyboard, a mouse, a touchpad, a touch screen, an electronic stylus, or other type of input device. Similarly, an input/output controller 232 may provide output to a display 205, such as a computer monitor, a flat-panel display, a digital projector, a printer, a plotter, or other type of output device. It will be appreciated that the computing device 200 may not include all of the components shown in FIG. 2, may include other components that are not explicitly shown in FIG. 2, or may utilize an architecture completely different than that shown in FIG. 2.

As described herein, a computing device may be a physical computing device, such as the computing device 200 of FIG. 2. A computing node may also include a virtual machine host process and one or more virtual machine instances. Computer-executable instructions may be executed by the physical hardware of a computing device indirectly through interpretation and/or execution of instructions stored and executed in the context of a virtual machine.

### Exemplary System Operation

Exemplary embodiments of the present disclosure may provide an efficient and reliable mechanism for managing and generating statement of work (SOW) rate cards and/or rate comparison outputs (e.g., reports), via one or more user interfaces, utilized by various entities, as described more fully below. For instance, one or more entities (e.g., managers) may implement a workflow for generating and managing requisitions (e.g., SOWs) using a computing device (e.g., a requisition computing system 102).

Referring now to FIG. 3, a diagram illustrating a create requisition interface 300 according to an example embodiment is provided. In the example embodiment of FIG. 3, the graphical user interface 112 may generate the create requisition user interface 300 during an initial requisition configuration process to configure one or more requisitions according to preferences of a manager (e.g., a manager overseeing/evaluating requisitions associated with RFPs, RFIs for submission to a service provider(s) and/or an electronic device programmed to evaluate requisitions associated with RFPs, RFIs for submission to a service provider(s)). It should be pointed out that during the initial requisition configuration process, the create requisition user interface 300 may detect input of one or more selections to generate one or more types of requisitions (also referred to herein as requisition types or statement of work (SOW) requisition types). In this regard, for example, the create requisition user interface 300 may be utilized to detect selections of preferences of an entity (e.g., a manager, a client/customer, etc.) and may generate a SOW requisition based on the detected selections. A SOW requisition may have multiple workforce resources associated with a SOW requisition in which each workforce resource associated with the SOW requisition may have an association(s) to a job category. The SOW requisition may also include one or more SOW categories/service categories.

As an example, the manager may obtain one or more workforce resources by creating a SOW requisition via, for example, the user device 108 and/or requisition computing system 102, indicating one or more openings/roles needed for completing work described in a SOW. The SOW requisition may be provided (e.g., via network 114) to the engagement support computing system 106 associated with one or more service providers. The SOW requisition may prompt, via a user interface (e.g., graphical user interface 112), one or more service providers to propose one or more candidate workforce resources associated with the service provider to complete work indicated in the SOW requisition. In an instance in which one or more workforce resources are hired, each workforce resource may be associated with a “role” (e.g., a job position) within the scope of the SOW requisition. A role may be uniquely associated with a particular workforce resource.

When creating or editing a SOW requisition for an organization (or division of an organization) that uses a global job taxonomy, a list of service classifications may include all service classifications associated with a global job taxonomy. When creating or editing a SOW requisition for an organization (or division of an organization) that uses a custom job taxonomy, a list of service classifications may include all service classifications associated with a custom job taxonomy.

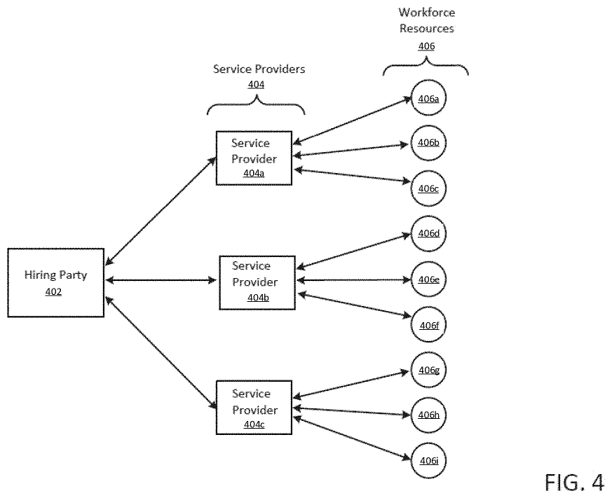

Referring to FIG. 4, in response to an entity such as, for example, a manager generating a SOW requisition, a server 101 (e.g., a vendor management server) may facilitate interactions between computing devices of customers, service providers, external parties, etc., with may determine a hiring party 402, a plurality of service providers 404 (e.g., suppliers 404a-c), and a plurality of workforce resources 406 (e.g., workforce resources 406a-i, which may be independent contractors). The hiring party 402 may be a party seeking to select and hire, or otherwise engage, a workforce resource 406 (e.g., individuals, workers) from the plurality of workforce resources 206. Each service provider 404 may be associated with one or more workforce resources 406 that are candidates for hire or are otherwise relevant to the hiring party's 402 request for work to be performed in accordance with the SOW. Although not necessarily shown in FIG. 4, a service provider 404 may be associated with other workforce resources 406 that are not relevant to the hiring party's 402 requisition.

A service provider 404 may serve as an intermediary (e.g., an intermediate party) between the hiring party 402 and the workforce resources 406 associated with a given service provider 404. A service provider 404 may comprise a contracting agency, for example, in which each workforce resource 406 may be associated and the contracting agency may assign one or more associated workforce resources 406 to work for or with the hiring party 402, for example, in accordance with terms specified in a SOW. As another example, a service provider 404 may comprise a general contractor that is associated with or has relationships with one or more workforce resources 406 (e.g., workers such as one or more carpenters, one or more masons, and one or more electricians).

Additionally or alternatively, the one or more associated workforce resources 406, as well as the service providers 404 may be associated with a location, such as a metropolitan area or a state in which the hiring party 402 operates or contemplates needing assistance. A metropolitan area may be defined according to a metropolitan statistical area (MSA). A location may comprise a postal code region.

The service provider 404 may promote, via, for example, engagement support computing system 106, one or more associated workforce resources 406 to fulfill the SOW in return for a percentage, or other measure, of the payment from the hiring party 402 for services or other benefits rendered by the one or more associated workforce resources 406. A service provider 404 may indicate, such as to the customer 402, a rate or cost for each associated workforce resource 406 scheduled to perform work in accordance with the SOW and/or the service provider's 404 markup. Payment from the hiring party 402 to each workforce resource 406 may be made via an associated service provider 404 using, for example, system 100.

The workforce resources 406, as well as the service providers 404 additionally or alternatively, may be associated with a job taxonomy. For example, the job taxonomy may comprise staff augmentation classifications or SOW classifications. Staff augmentation classifications may be referred to as ‘job classifications’ and SOW classifications may be referred to as ‘service classifications’. The job taxonomy may be used to name, describe and classify jobs based on, for example, a job category, skill, education level, certification, license, etc. For example, a job category may be associated with a particular type of construction, service, or manufacturing. A job category may comprise a particular skill, technology, or an accreditation or certification relating to a skill or technology. A job category may comprise a full-time work schedule or a part-time work schedule. A job category may comprise a group of job categories. For example, a job category may comprise a job category group, with the job category group comprising multiple individual job categories or even further job category sub-groups. A job category may be defined by a hiring party 402 or a third-party. A job category may also be defined according to a government agency, such as the United States Bureau of Labor Statistic's Standard Occupational Classification (SOC). A job taxonomy may comprise a collection of SOW service classifications that are associated with an organization or division of an organization.

A SOW default category may be utilized in instances in which an O*NET code association may not be available to be selected for association with a workforce resource of a service provider when the service provider responds to a requisition, RFP, an engagement, or service invoice. A global service category may be associated with an O*NET code, and a custom service category may be associated with a global service category and to its O*NET code. A service category may be associated with a given workforce resource. In instances in which a rate card is not required for a service category, service category options provided via a user interface of engagement support computing system 106 may include service classification categories having an associated O*NET code. As described above, a rate card may relate to information regarding how much a service provider may charge for a workforce resource to complete a project or task.

In an instance in which a manager, service provider, or admin user selects a workforce resource or a placeholder for a requisition, RFP, or engagement where an organization (or division of an organization) uses a custom job taxonomy, and a configuration of an applicable type of service invoice does not utilize rate cards, contents of a corresponding service category of a user interface may display service classification categories in which each category may access an O*NET code due to association with a global service category. In an instance in which a service provider or admin user selects a workforce resource on a service invoice's time line item presented via a user interface (e.g., via graphical user interface 112), contents of a corresponding service category presented via the user interface may provide relevant service classification categories where a classification category may access an associated O*NET code through an association with a global service category.

In instances where rate cards are utilized for service categories, when creating or editing a rate card for an organization or a division of an organization that uses a global job taxonomy, a list of service classifications may include all service classifications associated with the global job taxonomy. When creating or editing a global ‘time’ rate card, a list of service categories may include all categories under a selected service classification associated with a given O*NET code. When creating or editing a global ‘task’ or ‘material’ rate card, a list of service categories may include all categories under a selected service classification. When creating or editing a rate card for an organization or a division of an organization that uses a custom job taxonomy, a list of service classifications may include all service classifications associated with a custom taxonomy. When creating or editing a custom ‘time’ rate card, a list of service categories may include all categories under a selected service classification having a global service category association having an associated O*NET code. When creating or editing a custom ‘task’ or ‘material’ rate card, a list of service categories may include all categories under a selected service classification.

Work performed by a given workforce resource 406 associated with a SOW may be documented in an associated timesheet. A timesheet may be defined according to a time unit (e.g., a day, a week, etc.) and indicate work performed, if any, for each of one or more time units represented in the timesheet. The work performed for a given time unit may be captured as a “project record.” In addition to indicating a particular time unit and the work performed during (or otherwise associated with) the time unit, a project record may indicate related data, such as the workforce resource 406, the project associated with the workforce resource 406, the job category, the location, the rate billed to the hiring party 402, and the rate paid each workforce resource 406.

For example, a per-day timesheet for a particular workforce resource 406 may cover a week and indicate the hours worked, if any, for each day of the week. A project record may be created for each day worked and indicate the units (e.g., hours, days, etc.) worked that day. If the example per-day timesheet indicates that the workforce resource 406 worked on Monday for 6 hours and Wednesday for 8 hours, two project records may be created. A first project record may indicate the 6 hours worked on Monday and a second project record may indicate the 8 hours worked on Wednesday. The first and second project records may be associated with the workforce resource's 406 associated project. Additional timesheets for the workforce resource 406 covering additional weeks may be also submitted. Thus, a workforce resource 406 and/or associated project may be associated with multiple timesheets and each of the multiple timesheets may be associated with multiple project records for work associated with an SOW. Additionally, a workforce resource 406 and/or associated project may be associated with multiple project records. Further, a requisition originated by the hiring customer 402 may be associated with multiple project records.

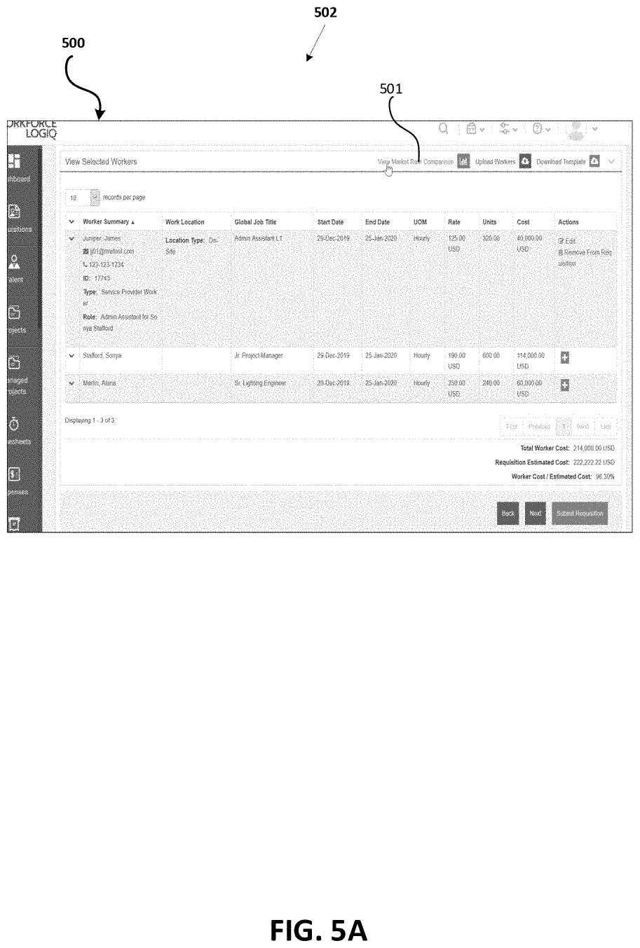

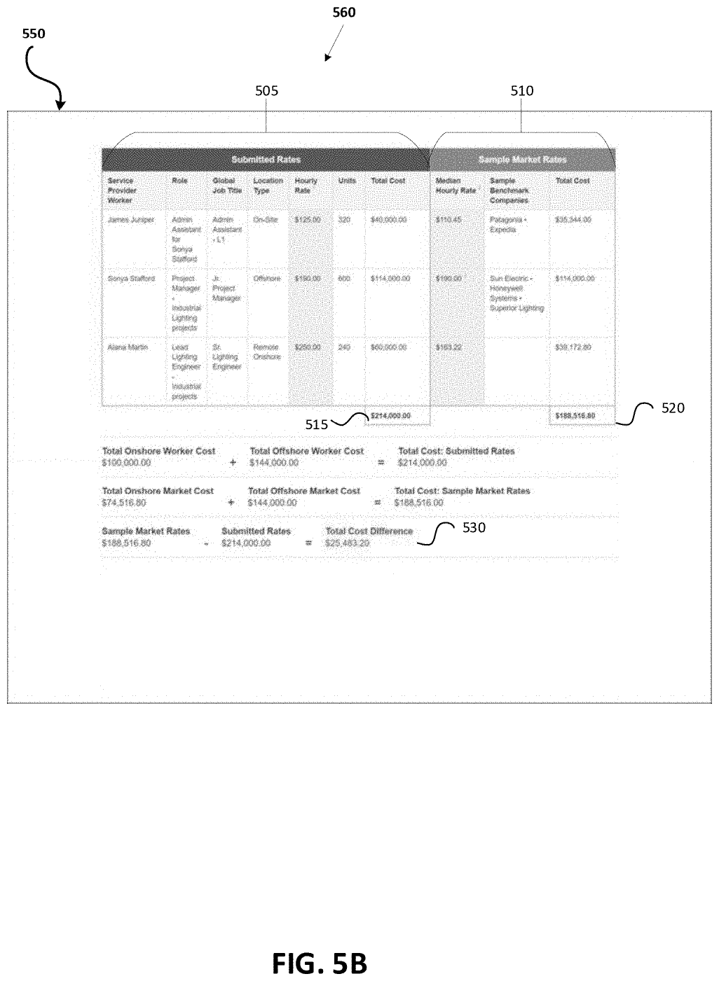

Referring to FIG. 5A, in response to an entity (e.g., a hiring party (e.g., a manager or customer)) generating a SOW, a computing device (e.g., server 101) may generate a requisition page 500 (e.g., a web page) in response to a selection of a service provider's submission to fulfill a SOW. The requisition page 500 may be presented/displayed via a user interface 502. The user interface 502 may be generated via a GPU (e.g., GPU 202).

The requisition page 500 may include workforce resources (e.g., workers) the service provider has designated to complete work outlined within the SOW. The requisition page 500 may indicate a title for each of the workforce resources submitted by the service provider. The requisition page 500 may include rate information (e.g., hourly rates) for each of the workforce resources, work units (e.g., per hour and number of budgeted hours) for workforce resources submitted in response to the SOW. The requisition page 500 may indicate a total submitted cost for all workforce resources submitted in response to the SOW, as well as, an estimated budget for workforce resources associated with the SOW.

To obtain insight into the reasonableness of the submission provided by the service provider, a computing device of the entity may obtain a market comparison report which compares the rates submitted by the service provider to sample market rates for workforce resources by selecting a market rate comparison tab 501 within the requisition page 500.

Referring to FIG. 5B, in response to a detection of a selection (e.g., a selection by the entity), of the market rate comparison tab 501, a computing device (e.g., server 101) may generate a market comparison report 550, presented via a user interface 560 (also referred to herein as market comparison user interface 560), in response to a service provider's submission to fulfill a SOW. The market comparison user interface 560 may be generated via by a GPU (e.g., GPU 202).

The market comparison report 550 may include submitted rates 505. The computing device (e.g., server 101) may receive submitted rates 505 associated with the SOW based on received rate information. The computing device may receive the rate information from an engagement support computing system 106 of a service provider. The rate information may include a given market rate for each workforce resource associated with a service provider's submission. The submitted rates 505 may include data related to one or more roles, job titles location types, rate information (e.g., hourly rates) and work units (e.g., per hour) for workforce resources submitted in response to the SOW. The computing device (e.g., server 101) may analyze the submitted one or more roles, job titles location types, rate information (e.g., hourly rates) and work units (e.g., per hour) to determine a total cost for each workforce resource associated with the service provider's submitted rates, as well as a total submitted cost, which may be a cumulative amount of total costs 515 for all workforce resources submitted by the service provider in response to the SOW.

The market comparison report 550 may include sample market rates 510. The sample market rates 510 may indicate a sample market rate for each workforce resource determined from the submitted rates. The sample market rates 510 may be a standard/average/median rate associated with a job category for a workforce resource, which may be based on a location or location type (e.g., on-site, offshore, etc.), that may not be specific to a particular hiring party such as a customer. Each standard/average/median rate may be based on rate data from one or more companies (e.g., benchmark companies) having a similar role, which may (but need not) be in the same industry as the customer. When a location type for a workforce resource submitted by a service provider is designated as offshore, a median hourly rate may be the same as the submitted hourly rate by the service provider. When a location type for a workforce resource submitted by a service provider is designated as null, on-site, or remote onshore, a median hourly rate may be a 50th percentile resource rate obtained from a third-party entity (e.g., CareerBuilder™) plus 65%. However, other resources for rate information may be used and other mark-ups may be applied. For example, rate information based on a job type and/or a location may be retrieved from a resource such as a repository or may be aggregation of market rate data.

The sample market rates 510 may be associated with one or more entities (e.g., companies (e.g., Patagonia™, Expediai™, etc.)). For example, the sample market rates 510 may be associated with information for a number (e.g., three, etc.) companies that contribute the greatest number of records to an entity's (e.g., CareerBuilder) 50th percentile calculation for a particular service category and location. In addition, other data, calculations, and/or filters may be used to determine sample market rates 510.

When determining the sample market rates 510, the computing device (e.g., server 101) may analyze one or more roles, job titles location types, rate information (e.g., hourly rates) and work units (e.g., per hour or a duration (e.g., Selected Workers End Date or Requisition/Engagement End Date minus Selected Workers Start Date or Requisition/Engagement Start Date)) to determine a total cost (Units*Hourly Rate) for each workforce resource associated with the service provider submission, as well as a total submitted cost 515, which may be a cumulative amount of total costs for all workforce resources submitted by the service provider in response to the SOW. For example, the computing device (e.g., server 101) may correlate the role and/or job title with a global or custom job taxonomy. Utilizing the global or custom job taxonomy in conjunction with a location of the workforce resource and other location type information, the computing device may output the total cost for each workforce resource associated with the service provider's submission, as well as the total submitted cost.

Based on detected input of the one or more job categories and/or locations, the computing device may cause output, via a user interface, of one or more service providers and associated submitted rates having one or more workforce resources that have responded to a SOW, (e.g., a predetermined number of workforce resources needed to complete work associated with the SOW). In some examples, the one or more service providers caused to be output may be associated with a lowest service provider markup, a lowest workforce resource payment rate, or other most-favorable characteristics of service providers.

The market comparison report 550 may include a total cost of submitted rates. The total cost of submitted rates may be based on a total onshore worker cost and a total offshore worker cost. The total onshore worker cost may be a sum total of all values in a total cost column associated with the submitted rates 505. The total offshore worker cost may be a sum total of all values in a total cost column associated with the submitted rates 505 where an associated location type is offshore.

The market comparison report 550 may include a total cost of sample market rates. The total cost of sample market rates may be based on a total onshore market cost and a total offshore market cost. The total onshore market cost may be a sum total of all values in a total cost column associated with the sample market rates 510 where an associated location type is either on-site, or remote onshore. The total offshore market cost may be a sum total of all values in a total cost column associated with the sample market rates 510 where an associated location type is offshore. The market comparison report 550 may further include a total cost difference 530 determined by the computing device (e.g., server 101). The total cost difference 530 may be determined by the computing device (e.g., server 101) based on subtracting sample market rates from submitted rates. In the example of FIG. 5B, the total cost difference 530 (e.g., $25,483.20) may be a negative amount indicating that the costs of the submitted rates are more than the costs of the sample market rates. In some examples, this may denote that the sample market rates are more competitive and may be used as a benchmark to gauge the reasonableness (e.g., a reasonable markup) of the submitted rates by the service provider. In other example embodiments, the cost difference 530 may be a positive amount, which also may be utilized to determine the reasonableness of the submitted rates.

The user interface 560 may include one or more elements that enable a user (e.g., manager, etc.) to select a service provider associated with workforce resources that may fulfill work requirements of the SOW and engage the selected service provider to coordinate the completion of work associated with the SOW by one or more workforce resources.

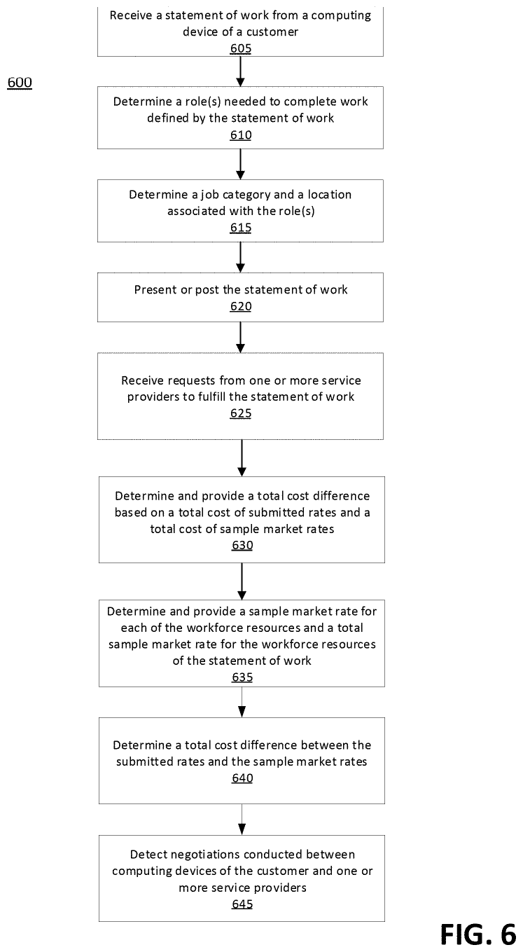

FIG. 6 is a flowchart of an example method 600 for negotiating a statement of work according to one or more exemplary embodiments. At block 605, a server (e.g., server 101 such as a vendor management server) may receive, from a computing device (e.g., requisition computing system 102) of a customer, a SOW defining work that is needed to be performed. In some examples, the customer may be a hiring party desiring to fill one or more positions to complete a project or task. At block 610, the server may analyze the SOW and determine one or more roles needed to complete the work defined in the SOW. At block 615, the server may determine a job category and/or location associated with each of the one or more roles.

At block 620, the server may present (or post) the SOW to a user interface (e.g., a user interface generated by GPU 202) to solicit responses from a computing device (e.g., engagement support computing system 106) of one or more service providers. At block 625, the server may receive a response to the SOW from the computing device of one or more service providers.

At block 630, the server may determine and provide submitted rates to the computing device (e.g., requisition computing system 102) of the customer. The submitted rates may be received from an associated service provider. The submitted rates provided by the service provider may indicate a rate for a workforce resource for each role of one or more roles needed to complete the work defined in the SOW. The server may also provide a total cost for all submitted rates for workforce resources associated with the one or more roles needed to complete the work defined in the SOW. At block 635, the server may determine and provide sample market rates to the computing device of the customer. The sample market rates provided may indicate a sample market rate for a workforce resource for each role of one or more roles needed to complete the work defined in the SOW. Each sample market rate may be determined by the server based on rate data obtained from one or more entities (e.g., companies) having a similar role, which may (but need not) be in the same industry as the customer. In some examples, the server 101 may obtain the rate data from the third-party computing system 104. The server may also determine and provide a total cost for all sample market rates for workforce resources associated with the one or more roles needed to complete the work defined in the SOW. At block 640, the server may determine and provide a total cost difference to the computing device of the customer. The total cost difference may be a result of the total cost for all submitted rates for workforce resources associated with the one or more roles needed to complete the work defined in the SOW subtracted from the total cost for all sample market rates for workforce resources associated with the one or more roles needed to complete the work defined in the SOW.

At block 645, the server may detect one or more negotiations (e.g., electronic negotiations) for a SOW that may be conducted between the computing device (e.g., requisition computing system 102) of the customer and the computing device (e.g., engagement support computing system 106) of the service provider. Because the server provided the computing device of the customer with sample market rates for each workforce resource associated with a submitted job category and/or location, as well as a total cost difference, a number of negotiations (e.g., electronic negotiations) performed by the server for market rates may be reduced, enabling the server to reduce consumption of processing resources, conserve memory space and minimize network traffic (e.g., conserve network bandwidth).

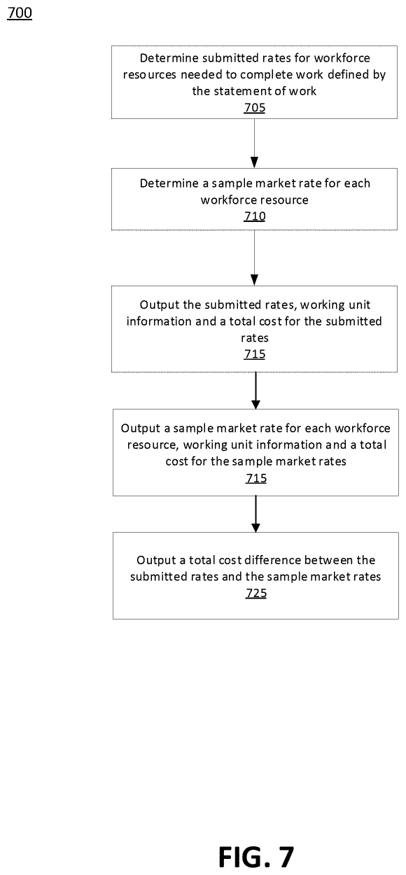

FIG. 7 is a flowchart of an example method 700 for negotiating a statement of work according to one or more exemplary embodiments. At block 705, a server (e.g., server 101 such as a vendor management server) may determine submitted rates for one or more workforce resources (e.g., workforce resources 406) needed to complete a SOW sent by a computing device (e.g., engagement support computing system 106) of one or more service providers. At block 710, the server may determine a job category and/or location associated with each of the one or more workforce resources (e.g., workforce resource 406), which may be used by the server to determine a sample market rate for each of the one or more workforce resources. In some examples, each sample market rate may be determined by the server based on rate data obtained from one or more entities (e.g., companies) having a similar role. At block 715, the server may output/present the submitted rates, a number of working units and a total cost associated with the submitted rates in a report (e.g., market comparison report 550) to a user interface (e.g., market comparison user interface 560). At block 720, the server may output/present the sample market rate for each of the one or more resources, a number of working units and a total cost associated with the sample market rates in the report (e.g., market comparison report 550). At block 725, the server may output/present a total cost difference (e.g., $25,483.20), which may be a difference between the total cost associated with the submitted rates and the total costs associated with the sample market rates in the report (e.g., market comparison report 550) presented via the user interface (e.g., market comparison user interface 560). In some examples, the server may provide the report to a communication device (e.g., user device 108) for display.

Accordingly, methods, apparatuses and systems disclosed herein may enable entities such as, for example, hiring parties or customers to submit a SOW to communication devices of service providers and receive responses from the service providers, via the communication device. The responses may indicate one or more workforce resources that may be required based on the work to be performed defined in the SOW. The customer may be provided with sample market rate information, via the communication device (e.g., server 101), based on roles, job category, and location. The communication device may determine a total onshore market cost and a total offshore market cost.

Accordingly, a customer may compare sample market rates to submitted rates from service providers in response to a SOW to obtain market insight into market rates for workforce resources needed to complete the work defined in the SOW. The customer may use this insight to negotiate favorable market rates with service providers when obtaining workforce resources. Accordingly, the exemplary methods, apparatuses and systems disclosed herein may enable a customer to minimize or avoid overpayment for contingent workforce resources and thereby better control financial resources.

### Conclusion

Many modifications and other embodiments of the present disclosures set forth herein will come to mind to one skilled in the art to which these present disclosures pertain having the benefit of the teachings presented in the foregoing descriptions and the associated drawings. Therefore, it is to be understood that the present disclosures are not to be limited to the specific embodiments disclosed and that modifications and other embodiments are intended to be included within the scope of the appended claims. Moreover, although the foregoing descriptions and the associated drawings describe exemplary embodiments in the context of certain exemplary combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

What is claimed:

1. An apparatus comprising a processor and a memory, the memory storing computer-executable instructions which when executed by the processor, cause the apparatus to perform operations comprising:
determining submitted rates for one or more workforce resources associated with a requisition, wherein each of the one or more workforce resources is associated with a job type and a location;
determining, based on at least the job type and the location, a market pay rate for each of the one or more workforce resources;
outputting, based on the submitted rates and a number of working units, a first total cost for each of the one or more workforce resources;
outputting, based on the market pay rate and the number of working units, a second total cost for each of the one or more workforce resources; and
outputting a function of the first total cost and the second total cost.

2. The apparatus of claim 1, wherein the job type of a select workforce resource comprises an offshore type and the market pay rate for the select workforce resource is set as the submitted rate for the select workforce resource.

3. The apparatus of claim 1, wherein the market pay rate is determined as a function of a market rate retrieved from an entity.

4. The apparatus of claim 3, wherein the function is a mark-up of the market rate retrieved from the entity.

5. The apparatus of claim 3, wherein the entity comprises a repository of information associated with workforce resources having a same or similar job type or location, or both as the one or more workforce resources.

6. The apparatus of claim 3, wherein the market rate retrieved from the entity is a median hourly rate selected based on the job type and location of the one or more workforce resources.

7. The apparatus of claim 1, wherein the function of the first total cost and the second total cost comprises a difference of first total cost and the second total cost.

8. The apparatus of claim 1, wherein when the processor further executes the instructions, the processor further causes the apparatus to:
detect one or more negotiations between a first computing device of a customer and a second computing device of at least one service provider in response to the requisition.

9. A method comprising:
determining submitted rates for one or more workforce resources associated with a requisition, wherein each of the one or more workforce resources is associated with a job type and a location;
determining, based on at least the job type and the location, a market pay rate for each of the one or more workforce resources;
outputting, based on the submitted rates and a number of working units, a first total cost for each of the one or more workforce resources;
outputting, based on the market pay rate and the number of working units, a second total cost for each of the one or more workforce resources; and
outputting a function of the first total cost and the second total cost.

10. The method of claim 9, wherein the job type of a select workforce resource comprises an offshore type and the market pay rate for the select workforce resource is set as the submitted rate for the select workforce resource.

11. The method of claim 9, wherein the market pay rate is determined as a function of a market rate retrieved from an entity.

12. The method of claim 11, wherein the function is a mark-up of the market rate retrieved from the entity.

13. The method of claim 11, wherein the entity comprises a repository of information associated with workforce resources having a same or similar job type or location, or both as the one or more workforce resources.

14. The method of claim 11, wherein the market rate retrieved from the entity is a median hourly rate selected based on the job type and location of the one or more workforce resources.

15. The method of claim 9, wherein the function of the first total cost and the second total cost comprises a difference of first total cost and the second total cost.

16. The method of claim 9, further comprising detecting one or more negotiations between a first computing device of a customer and a second computing device of at least one service provider in response to the requisition.

17. A computer readable storage medium storing executable instructions that when executed by a computing device cause the computing device to effectuate operations comprising:
determining submitted rates for one or more workforce resources associated with a requisition, wherein each of the one or more workforce resources is associated with a job type and a location;
determining, based on at least the job type and the location, a market pay rate for each of the one or more workforce resources;
outputting, based on the submitted rates and a number of working units, a first total cost for each of the one or more workforce resources;
outputting, based on the market pay rate and the number of working units, a second total cost for each of the one or more workforce resources; and
outputting a function of the first total cost and the second total cost.

18. The computer readable storage medium of claim 17, wherein the market pay rate is determined as a function of a market rate retrieved from an entity.

19. The computer readable storage medium of claim 17, wherein the function of the first total cost and the second total cost comprises a difference of first total cost and the second total cost.

20. The computer readable storage medium of claim 17, further comprising detecting one or more negotiations between a first computing device of a customer and a second computing device of at least one service provider in response to the requisition.
